(19) United States
(12) Patent Application Publication
(10) Pub. No.: US 2020/0389944 A1
(43) Pub. Date: Dec. 10, 2020

(54) CARTRIDGE HEATER COVER

(71) Applicant: Resistencias Industriales Maxiwatt, S.L., Elche (ES)

(72) Inventor: Jose Rodriguez Rodenas, Elche (ES)

(21) Appl. No.: 16/782,553

(22) Filed: Feb. 5, 2020

(30) Foreign Application Priority Data
Jun. 6, 2019 (ES) U201930950

(51) Int. Cl. H05B 3/40; H05B 3/20

(52) U.S. Cl. CPC H05B 3/40; H05B 3/20

(57) ABSTRACT

The invention relates to a cartridge heater cover, which has a metal plate that can be coupled to the end of the cartridge heater wherefrom the wiring protrudes, and which has a threaded through hole in the plate.

### CROSS REFERENCE TO RELATED APPLICATION

This application claims the benefit of priority of Spanish Patent Application No. U201930950, filed on Jun. 6, 2019, application which is incorporated herein in its entirety for all purposes.

### FIELD OF THE INVENTION

The present invention belongs to the field of industrial thermal and heating solutions, specifically to cartridge heaters used to generate energy in the form of heat for a variety of industrial processes. More specifically, the present invention belongs to the field of cartridge heaters for heating moulds by introducing and adjusting the heaters therein.

### BACKGROUND OF THE INVENTION

At present, there is a wide variety of electrical resistors for generating energy in the form of heat, and among them, there are different types of cartridge heaters used for heating in a wide variety of industrial processes and with different areas of application, such as gearboxes, laboratories, printing, textiles, bag sealing, etc.

The most relevant application of cartridge heaters is the heating of molds by introducing and adjusting the heaters inside said molds.

Cartridge heaters have an outer metal sheath, which will be in direct contact with the mold or body to be heated. Depending on the application, it can be made of different metals and alloys, mainly stainless steel or nickel-based superalloys. Inside the sheath a coil is housed, which is usually made of nickel-chromium, and it provides heat energy upon being supplied by electrical current through wiring that protrudes from one end of the sheath. The foregoing are the essential components of a conventional cartridge heater, although depending on the application, they can have other components such as ceramic elements to reduce vibrations or compacted magnesium oxide to maximize thermal insulation and conductivity of the cartridge.

Cartridge heaters are designed and manufactured according to the physical, electrical and thermal features of the mold or product to be heated, such that, given these features, the diameter, length and shape of the outer sheath thereof, as well as the voltage and power supplied, will vary. However, the most common cartridge heaters are cylindrical straight tubes having diameters ranging from 6 mm to 35 mm. The length of the most common cartridges typically varies in size from 35 mm to 1500 mm, depending on the application.

The most important aspect for the adequate functioning of the cartridge heaters is the correct adjustment in the mold or body to be heated, given that if the adjustment is inadequate, there will not be direct and complete contact between the sheath and the surface of the cavity wherein the cartridge is inserted, and complete dissipation of the heat energy will not take place, which will cause the internal temperature of the cartridge to increase until the heater is burned. Therefore, for the correct functioning of the cartridge heater, careful adjustment is essential to ensure complete contact between the outer sheath and the cavity of the mold or body to be heated.

The drawback presented by current cartridge heaters is that to obtain this close-fitting adjustment with complete contact between outer sheath and cavity, cavities are made in the mold and body to be heated with hardly any clearance in relation to the diameter of the cartridge. This causes the cartridge to remain completely fitted in the cavity of the mold or body to be heated, leading to problems in the removal of the cartridge from the cavity once the heating process has ended. This removal is carried out by pulling the wiring that protrudes from the end of the cartridge, and as the cartridge fits so tightly in the cavity, the effort made can deteriorate the cartridge, and in some cases, the wiring is pulled out, remaining inside the cavity of the cartridge, this cartridge becoming completely useless. Moreover, it is necessary to remove the cartridge by other means, such as for example drilling, which causes damages to the mold or body, in addition to the time and cost of this removal operation.

Therefore, a means that facilitates the removal of the cartridge heaters from the molds or bodies wherein they are inserted in a simple and efficient manner is desirable, preventing the drawbacks of the cartridges in the state of the art.

### DESCRIPTION OF THE INVENTION

The present invention resolves the existing problems in the state of the art by means of a cartridge heater cover, which has a metal plate that can be coupled to the end of the cartridge heater wherefrom the wiring protrudes, which has a threaded through hole in said plate. The metal plate is joined to the cartridge heater by welding to the outer sheath of said cartridge.

With this configuration, the removal of the cartridge heater from the cavity of the mold or body wherein it is inserted can be carried out by using a screw or any threaded rod having the same measurements as the through hole of the plate. The screw or threaded rod is threaded into the hole, and once inserted, it is used as a handle to comfortably pull and remove the cartridge, thereby preventing any damage to said cartridge.

Preferably, the plate will be made in a circular shape to adapt to the shape of the end of the outer sheath of the cartridge, if this cartridge has a circular section, although it could have other shapes, such as for example, square or rectangular to adapt to tubes of said sections, or any other shape as long as it facilitates welding to the end of the cartridge.

Likewise, the hole is also preferably centered on the plate, to centralize the point of application of the force for removing the cartridge and facilitating the same.

Given that the wiring must project from the sheath of the cartridge to be able to establish the electric connection, it will be possible to weld the plate of the cover to the end of the sheath, leaving a space for the wiring to come out. Alternatively, the plate will at least have one opening for the wiring of the heater to come out.

According to the foregoing, and according to a preferred embodiment of the invention, the plate has two openings for the wiring to come out, one for each of the wires. Preferably, these two openings are separated, and in the case of circular plates, they will be diametrically opposite from each other on the perimeter of the plate. This embodiment provides an even distribution, preventing the wires from tangling or from being too close together.

### BRIEF DESCRIPTION OF THE DRAWINGS

In order to make the invention more readily understandable, by way of illustration and not limitation, an embodiment of the invention that refers to a series of figures is described below.

FIG. 1 is a schematic perspective view of a conventional cartridge heater.

FIG. 2 is a perspective view of an embodiment of a cartridge heater cover object of the present invention.

FIG. 3 is a plan view of the embodiment of the cover of FIG. 2.

FIG. 4 is an elevation view of the embodiment of the cover of FIGS. 2 and 3.

FIG. 5 is a perspective view of a cartridge heater, at the end of which the cover object of the present invention has been welded.

FIG. 6 shows a perspective view of a threaded rod coupled to a cartridge heater with the cover object of the present invention.

FIG. 7 shows a cartridge heater inserted into a cavity of a mould or body, with the cover object of the invention and a threaded rod coupled thereto for its removal from the cavity.

These figures refer to a set of elements which are:
1. cartridge heater
2. plate
3. wiring of the cartridge heater
4. hole of the plate
5. openings of the plate
6. mold
7. screw

### DETAILED DESCRIPTION OF THE INVENTION

The object of the present invention is a cartridge heater 1 cover.

As can be seen in the figures, the cover has a metal plate 2, which couples to the end of the cartridge heater 1 wherefrom the wiring 3 protrudes. The cover has a threaded through hole 4 in the plate 2. The metal plate 2 is joined to the end of the cartridge heater 1 by welding to the outer sheath of said cartridge heater 1.

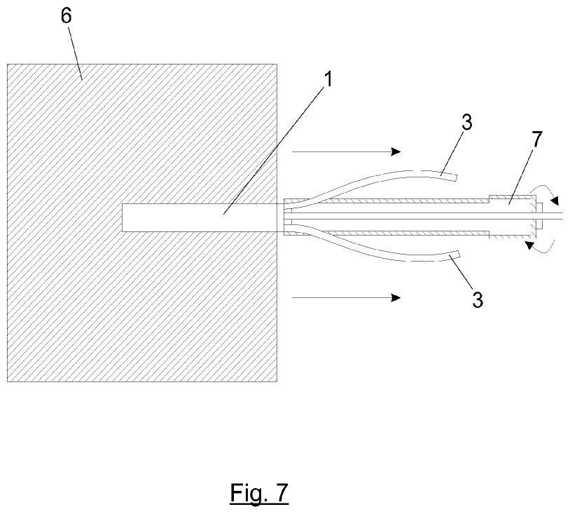

With this configuration, the removal of the cartridge heater 1 from the cavity of the mold 6 or body wherein it is inserted can be carried out by using a screw 7 or any threaded rod having the same measurements as the through hole 4 of the plate 2. The screw 7 or threaded rod is threaded into the hole 4 of the plate 2, and once inserted, it is used as a handle to comfortably pull and remove the cartridge heater 1 from the mold 6, thereby preventing any damage thereto. FIG. 6 shows a screw 7 coupled to a cartridge heater 1 with the cover object of the present invention. FIG. 7 shows a cartridge heater 1 inserted into a cavity of a mold 6 or body, with the cover object of the invention and a screw 7 coupled thereto for its removal from the cavity of the mold 6 or body.

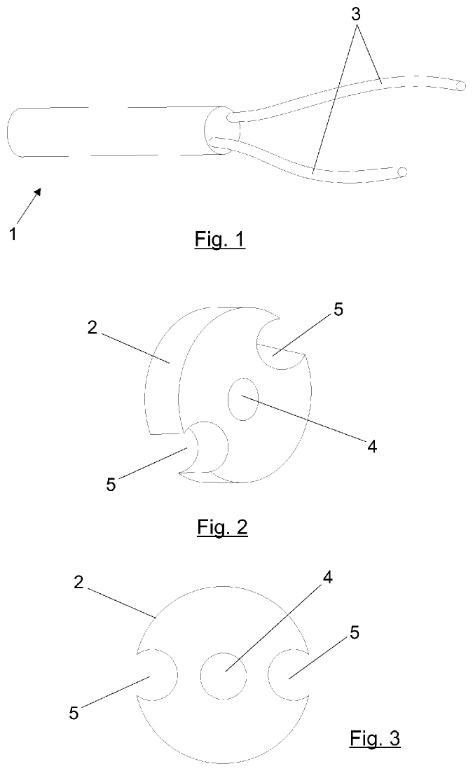

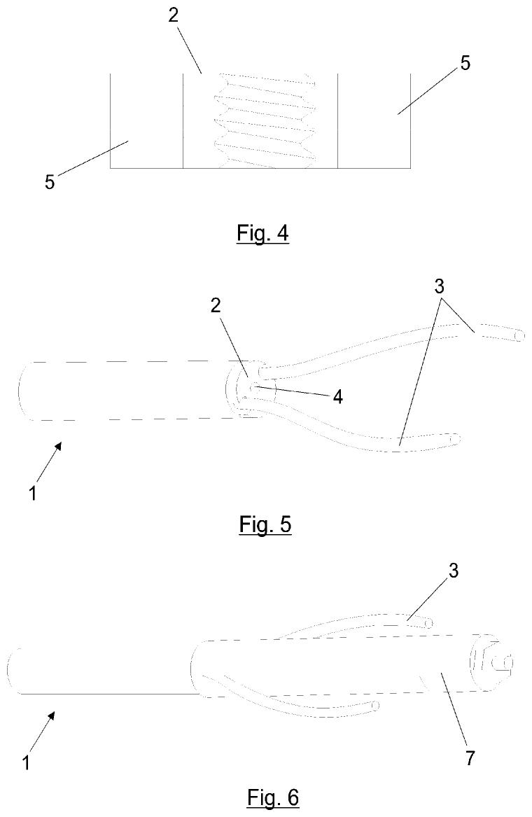

Preferably, as can be seen in FIGS. 2 and 3, the plate 2 has a circular shape to adapt to the shape of the end of the outer sheath of the cartridge heater 1, if this cartridge has a circular section, although it could have other shapes, such as for example, square or rectangular to adapt to tubes of said sections, or any other shape as long as it facilitates welding to the end of the sheath of the cartridge heater 1.

Likewise, the hole 4 is preferably centered on the plate 2, as seen in FIG. 3, to centralize the point of application of the force for removing the cartridge heater 1 and facilitating the same.

Given that the wiring 3 must project from the sheath of the cartridge heater 1 to be able to establish the electric connection, it will be possible to weld the plate 2 of the cover to the end of the sheath, leaving a space for the wiring 3 to come out. Alternatively, the plate 2 will at least have one opening 5 for the wiring 3 of the heater 1 to come out.

According to the foregoing, and according to a preferred embodiment of the invention, as can be clearly seen in FIG. 3, the plate 2 of the cover has two openings 5 for the wiring 3 to come out, one for each of the wires. Preferably, these two openings 5 are separated, and in the case of circular plates 2, they will be diametrically opposite from each other on the perimeter of the plate 2. This embodiment provides an even distribution, preventing the wires from tangling or from being too close together.

1. A cartridge heater cover, comprising a metal plate coupled to an end of a cartridge heater wherein a wiring protrudes, and wherein the metal plate comprises a treaded through hole.

2. The cartridge heater cover, according to claim 1, wherein the metal plate has a substantially circular shape.

3. The cartridge heater cover, according to claim 2, wherein the treaded through hole is centered on the plate.

4. The cartridge heater cover, according to claim 1, wherein the plate comprises at least one opening for the wiring to come out of the cartridge heater.

5. The cartridge heater cover, according to claim 4, wherein the plate comprises two openings for the wiring to come out of the cartridge heater.

6. The cartridge heater cover, according to claim 5, wherein the two openings are diametrically opposite from each other on a perimeter of the plate.
